(19) United States
(12) Patent Application Publication
(10) Pub. No.: US 2005/0057004 A1
(43) Pub. Date: Mar. 17, 2005

(54) Stainless steel plate, method of manufacturing the same, and rubber-coated stainless steel plate gasket

(75) Inventors: Osamu Yamazaki, Tokyo (JP); Toshiyuki Yashiro, Tokyo (JP); Nobuhiro Numazawa, Tokyo (JP); Eiichi Osada, Tokyo (JP); Masaru Okamoto, Akaiwa-Gun (JP); Kazuhiro Takahashi, Akaiwa-Gun (JP); Ritsuko Yokota, Akaiwa-Gun (JP); Hirofumi Fukawa, Akaiwa-Gun (JP)

Correspondence Address: SUGHRUE MION, PLLC, 2100 PENNSYLVANIA AVENUE, N.W., SUITE 800, WASHINGTON, DC, 20037, US

(73) Assignees: NIPPON KINZOKU CO., LTD; UCHIYAMA MANUFACTURING CORP.

(21) Appl. No.: 10/895,334

(22) Filed: Jul. 21, 2004

(30) Foreign Application Priority Data
Jul. 22, 2003 (JP) 2003-199802

(51) Int. Cl. F02F 11/00

(52) U.S. Cl. 277/592

(57) ABSTRACT

This invention provides a rubber-coated stainless steel plate suitable as a gasket core material with excellent adhesion to the rubber layer, a method of manufacturing the same, and a gasket comprising the rubber-coated stainless steel plate. The following are provided by the present invention: a stainless steel plate having a roughened surface on which chrome hydroxide, chrome oxide, iron hydroxide, and iron oxide are deposited; a rubber-coated stainless steel plate formed by coating the surface of the stainless steel plate with a rubber layer; a gasket comprising the rubber-coated stainless steel plate; and a method of manufacturing the stainless steel plate, wherein the stainless steel plate is roughened with at least one of chemical roughening and electrochemical roughening and is then subjected to cathode electrolytic treatment in an alkaline solution.

### FIELD OF THE INVENTION

The present invention relates to a gasket core material made of a rubber-coated stainless steel plate, which is used for an engine part of a motor vehicle, etc., a method of manufacturing the gasket core material, and a gasket using the core material.

### BACKGROUND ART

Conventionally, gaskets used in engines of motor vehicles were made mainly of asbestos. However, due to environmental problems, in place of asbestos, “gaskets made of rubber-coated stainless steel plates” are widely used. These gaskets are created by applying adhesive to the surface of a stainless steel plate used as a core material and then forming a heat-resistant rubber layer such as fluorocarbon rubber, or NBR rubber thereon. However, adhesion of the stainless steel plate to the heat-resistant rubber, that is, adhesion of the surface of the stainless steel plate to the adhesive, is not good. This is a particular problem for an engine gasket for a motor vehicle because engine cooling water (antifreeze solution) penetrates the end face of the gasket to which the bonding portion of the rubber layer and the stainless steel plate is exposed due to being repeatedly struck, thereby deteriorating the bonding durability of the rubber layer. Therefore, various techniques for enhancing the bonding between the stainless steel plate and the rubber layer and improving the bonding durability of the rubber layer in the presence of an antifreeze solution have been studied.

In recent years, a coat-type chromate treatment wherein a chromate treatment solution is applied to a substance to be treated has entered main stream use as a pre-treatment for bonding rubber to a gasket core material made of a stainless steel plate. In the coat-type treatment, well-known methods such as a roll coating method, an air curtain method, an electrostatic spraying method, and a squeeze roll coating method can be used without a treatment bath. In addition, these methods do not produce sludge. Examples of the chromate treatment solution include chromic anhydride, chromate, and bichromate which contain hexavalent chrome as a major component, as well as solutions created from the above liquids by adding phosphoric acid, silica gel, resin, etc. Furthermore, Patent Document 1 discloses a method of forming a chromate coating layer on a stainless steel plate and then forming a rubber layer thereon by using an adhesive. In addition, Patent Document 2 discloses a method of improving wettability for a coat-type chromate treatment and uniformly coating a chromate film.

A different method of mechanically roughening the surface of the stainless steel plate by means of dull-roll rolling, shot blasting, etc. to enhance the adhesion to rubber has been tried. In addition, Patent Document 3 discloses yet a different method of enhancing the adhesion to rubber by performing cathode electrolytic treatment on the surface of the stainless steel plate in an alkaline solution to form an iron hydrate oxide coating film to improve the wettability of the adhesive.

The method disclosed in Patent Document 1, in which a rubber layer is formed by using an adhesive layer on a stainless steel plate subjected to a chromate treatment to obtain stable adhesion to the rubber layer, uses hexavalent chrome that is noxious to the environment. Therefore, this method can be used only in a plant equipped with a waste treatment facility. Additionally, the main component of the chromate film is soluble hexavalent chrome, and it may be eluted into the engine cooling water (antifreeze solution) of a motor vehicle from the chromate layer of the end face of the gasket if the bonding portion between the rubber layer and the stainless steel plate is exposed due to being repeated struck. Furthermore, the hexavalent chrome may be eluted from the gasket of a scrapped car by rainfall, etc., thereby causing soil pollution.

On the other hand, the method of mechanically roughening dull-roll rolling wherein unevenness formed on a rolling roll is transferred to the surface of the stainless steel plate is unsatisfactory, because it is difficult to obtain a sufficiently high anchor effect to hold the rubber layer to the roughened surface. Roughening methods such as shot blasting or honing can produce a roughened surface having a relatively high anchor effect. However, processing cut-out steel powder decreases work efficiency. In addition, thin steel plates commonly used as the gasket core material are easily bent. Therefore, these roughening methods are not suitable for the gasket core material.

Furthermore, the method disclosed in Patent Document 3 suffers from the disadvantage of having a very low production efficiency. In this method, the surface of the stainless steel plate is subjected to cathode electrolytic treatment in an alkaline solution to form an iron hydrate oxide coating film on the surface of the stainless steel plate to improve the wettability of the adhesive and enhance its adhesion to the rubber. The problem is that the alkaline electrolyte is depleted by the electrolytic treatment so after several hours of using the solution, a coating film with good adhesion to rubber cannot be obtained and the solution must be replaced.
[Patent Document 1] Japanese Unexamined Patent Publication No. H3-265764
[Patent Document 2] Japanese Unexamined Patent Publication No. H7-18460
[Patent Document 3] Japanese Unexamined Patent Publication No. H5-65697

### SUMMARY OF THE INVENTION

The present invention is designed to solve the existing technical problems found in the prior art (Patent Documents 1, 2, and 3). It is thus an object of the present invention to provide a gasket core material made of a rubber-coated stainless steel plate with good adhesion to the rubber layer, without using environmentally harmful hexavalent chrome, and by using a technology that makes efficient production possible.

The present invention provides a stainless steel plate, a rubber-coated stainless steel plate, a gasket comprising the rubber-coated stainless steel plate, and a method of manufacturing the stainless steel plate, which are all described below.

1. A stainless steel plate with a roughened surface on which chrome hydroxide, chrome oxide, iron hydroxide, and iron oxide are deposited.

2. The stainless steel plate according to the above item 1, wherein the roughened surface has etch pits with an average diameter and an average depth of 0.5 to 10 μm.

3. The stainless steel plate according to the above item 1 or 2, wherein the stainless steel plate is an austenitic stainless steel plate or a stainless steel plate with a multiphase structure of ferrite and martensite with a hardness of Hv 300 to 500 and an average thickness of 0.1 to 2.0 mm.

4. A rubber-coated stainless steel plate formed by coating the surface of the stainless steel plate according to any one of the above items 1 to 3 with a rubber layer.

5. A rubber-coated stainless steel plate formed by coating the surface of the stainless steel plate according to any one of the above items 1 to 3 with a rubber layer by using an adhesive layer.

6. The rubber-coated stainless steel plate according to the above item 4 or 5, wherein the rubber layer has an average thickness of 10 to 500 μm.

7. The rubber-coated stainless steel plate according to any one of the above items 4 to 6, wherein the rubber layer is made of one selected from a group consisting of fluorocarbon rubber, silicone rubber, fluorosilicone rubber, hydrogenated acrylonitrile butadiene rubber, acrylic rubber, acrylonitrile butadiene rubber, mixture of two or more thereof, or a compound obtained by using one of the above rubbers as a binder in combination with an inorganic or organic fiber or in combination with an inorganic or organic filler.

8. A gasket comprising the rubber-coated stainless steel plate according to any one of the above items 4 to 7.

9. The gasket according to the above item 8, wherein the gasket is an engine gasket.

10. A method of manufacturing the stainless steel plate according to the above item 1 or 2, wherein the stainless steel plate is roughened with at least one of chemical roughening and electrochemical roughening and is subjected to cathode electrolytic treatment in an alkaline solution.

### BRIEF DESCRIPTION OF THE DRAWINGS

FIG. 1 is a graph illustrating results of the hexavalent chrome elution test of electrolytic deposits.

FIG. 2 is an electron micrograph of a roughened surface of a core material made of a stainless steel plate.

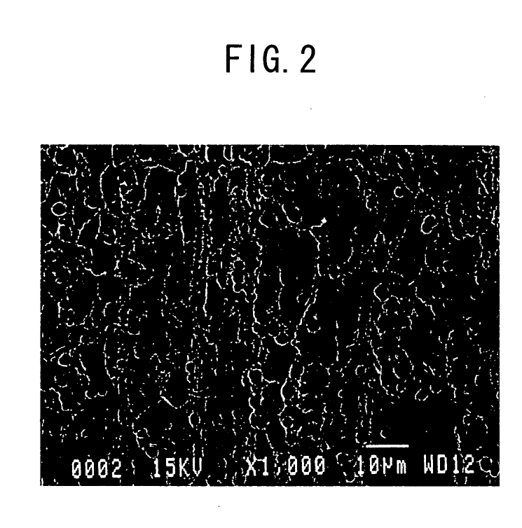

### DESCRIPTION OF THE PREFERRED EMBODIMENTS

The present inventors have studied various techniques for enhancing adhesion of a stainless steel plate to a rubber layer. They found a method to create a gasket made of a rubber-coated stainless steel plate with high resistance to antifreeze solution over a long time period. This is achieved by roughening the surface of the stainless steel plate into an uneven shape having an anchor effect, and subjecting it to a cathode electrolytic treatment in an alkaline solution to form a deposit of chrome hydroxide, chrome oxide, iron hydroxide, and iron oxide. This creates good adhesion for an adhesive on the roughened surface of the stainless steel plate and makes it possible to coat the plate with a rubber layer. Further, since soluble hexavalent chrome is not contained in the deposits formed through the cathode electrolytic treatment in the alkaline solution, hexavalent chrome cannot be eluted into engine cooling water (antifreeze solution) from the end face of the gasket if the bonding portion between the rubber layer and the stainless steel plate is exposed due to being repeatedly struck. Furthermore, since the hexavalent chrome cannot be eluted from the gasket of a scrapped car by rainfall, there is no possibility to cause soil pollution.

The present inventors have studied the method disclosed in Patent Document 3 in detail, and found that the deposits change shape as electrolysis proceeds. Within the first several hours of electrolysis after preparation of the solution, the deposits have a needle shape that changes to a particulate shape, and finally becomes a thin film coating the surface. The adhesion to rubber is excellent when the deposits have the needle shape, but the adhesion to rubber is greatly decreased as the shape of the deposits change to the particulate shape and to a thin film. For example, in a mixed solution of 40 g/l of sodium carbonate, 30 g/l of trisodium phosphate·12H₂O, and 20 g/l of sodium hydroxide at 80° C. with a cathode current density of 6 A/dm², the deposits have a needle shape (with a length of about 1 μm) until the electrolysis time reaches about 400 minutes. The deposits then change to the particulate shape (with a particle diameter of about 0.1 μm) when the electrolysis time is further increased, and to a thin film when the electrolysis time exceeds 2,000 minutes. Since the needle-shaped deposits with excellent adhesion to rubber cannot be formed after electrolysis has been running for several hours, the productivity of this method is very poor.

However, as a result of analyzing a composition of the deposited substance with X-ray photoelectron spectroscopy (XPS), the present inventors found that the atomic composition remains almost the same regardless of the shape of the deposits. They found that the composition has 10 to 11 atomic % of Cr, 5 to 7 atomic % of Fe, 46 to 49 atomic % of O, and 31 to 34 atomic % of C in either the needle shape, the particulate shape, or as a thin film. The inventors also found that in the deposits, chrome formed hydroxide of Cr(OH)₃ and oxide of Cr₂O₃, and iron formed hydroxide of FeOOH and oxides of Fe₃O₄ and Fe₂O₃.

Since the composition of the deposits was the same regardless of shape, and since the adhesion to rubber was good only in the needle shape, the present inventors estimated that the anchor effect could be greatly influenced by the shape of the electrolytic deposits. For this reason, the present inventors believed that adhesion between rubber and the stainless steel plate could be enhanced by creating unevenness with an anchor effect by forming deposits (of any shape) on the surface with the electrolytic treatment.

Therefore, in order to create an anchor effect on the surface of the core material made of the stainless steel plate, unevenness was created on the surface by immersion (chemical treatment) in an acid solution or by the electrolytic treatment. Following that, deposits of chrome hydroxide, chrome oxide, iron oxide, and iron hydroxide were formed on the roughened surface by using cathode electrolysis in an alkaline solution. As a result, it was found that a gasket made of a rubber-coated stainless steel plate with high resistance to an antifreeze solution could be obtained by roughening the stainless steel plate even when the deposits were a thin film.

Furthermore, in the above gasket, it is preferable that the core is made of an austenitic stainless steel plate or a stainless steel plate with a multiphase structure of ferrite and martensite having a hardness of Hv 300 to 500 and an average thickness of 0.1 to 2.0 mm, and that the rubber layer has an average thickness of 10 to 500 μm.

The gasket made from a rubber-coated stainless steel plate according to the present invention has the characteristic of an adhesive layer and a rubber layer strongly adhered to the stainless steel plate. This strong adhesion is created by roughening the surface of the stainless steel plate to provide an anchor effect and then by depositing chrome hydroxide, chrome oxide, iron oxide, and iron hydroxide, all of which have excellent adhesion to the adhesive, onto the roughened surface by using cathode electrolytic treatment in an alkaline solution.

(Method for Roughening the Surface of the Stainless Steel Plate)

Any process selected from the group consisting of a chemical roughening process, an electrochemical roughening process, and a roughening process combining the two roughening processes can be used for roughening the surface of the stainless steel plate. The surface roughening process is performed to form numerous etch pits (unevenness or bumpiness) on the surface of the stainless steel plate. For example, the stainless steel plate is subjected to electrolytic treatment such as potentiostatic electrolysis (temperature: 5 to 95° C., voltage: 0.1 to 50 V, and time: 0.1 to 30 min), constant-current electrolysis (temperature: 5 to 95° C., current density: 0.01 to 100 A/dm², and time: 0.1 to 30 min), alternating electrolysis (temperature: 5 to 95° C., frequency: 0.5 to 60 Hz, voltage: 0.1 to 50 V, current density: 0.01 to 100 A/dm², and time: 0.1 to 30 min), in an aqueous solution containing halogen ions (ferric chloride, hydrochloric acid, sodium chloride, sodium bromide, sodium iodide, etc.), or is subjected to immersion treatment in an aqueous solution containing halogen ions (ferric chloride, hydrochloric acid, magnesium chloride, potassium chloride, calcium chloride, or copper chloride) of 0.1 mass % to saturated concentrations of the respective reagents at 5° C. to the boiling point of the solution for 0.1 to 60 minutes. With these treatments, numerous etch pits can be formed on the whole surface of the stainless steel plate. The average diameter and the average depth of pit openings are preferably 0.5 to 10 μm, and most preferably 1 to 3 μm.

It is also preferable that the etch pits are formed with a density as high as possible. For example, it is preferable if the ratio of the surface area of the pit openings to the whole surface area of the stainless steel plate is 30% or more, and more preferably 50% or more. In a material with excellent pitting corrosion resistance, the etch pits tend to form in localized areas. This can be avoided by degreasing and cleaning with nitric acid-hydrofluoric acid or by performing alternating electrolytic treatment or anode electrolytic treatment in an aqueous solution of sodium sulfate as pre-treatment of the roughening surface. If this is done, the etch pits are formed at a high density on the whole surface of the stainless steel plate.

(Cathode Electrolytic Treatment in Alkaline Solution)

The preferable conditions for the cathode electrolytic treatment of the roughened stainless steel plate in the alkaline solution include but are not specifically limited to the following examples: a solution containing 0.2 to 40 mass % of sodium hydroxide, a solution containing 0.2 to 50 mass % of trisodium phosphate, a solution containing 0.2 to 40 mass % of sodium carbonate, or a mixture solution thereof. The temperature of the solution is preferably 20 to 95° C., the cathode current density is preferably 0.5 A/dm² or more, and the treatment time is preferably 10 seconds or more.

The above conditions are preferred for the following reasons. When there is less than 0.2 mass % of each reagent, it is difficult to obtain uniform deposits on the surface of the stainless steel plate and it is also difficult to obtain excellent adhesion to the adhesive and rubber. When there is more than the upper limit of each reagent, the solution is considerably degraded, and it is not economically advantageous. When the temperature of the solution is lower than 20° C., the current efficiency is low, so that the deposition rate of the deposits is low and the enhancement effect of adhesion is small. Although the treatment time can be shortened by raising the temperature of the solution, the water vaporization is intense, and it becomes difficult to control the solution concentration. Additionally, when the cathode current density is smaller than 0.5 A/dm² and when the process time is shorter than 10 seconds, the enhancement of adhesion is small. A conventional stainless steel plate is suitable for the anode. The deposits primarily containing hydroxides and oxides of chrome and iron are formed on the surface of the stainless steel plate treated in this way.

(Electrochemical Reaction and Material of Anode)

In an electrochemical reaction with the alkaline solution described above, when a ferrite stainless steel plate is used as an anode, iron and chrome are the major components eluted from the anode from the start of electrolysis. Iron elutes as Fe³⁺, forms Fe(OH)₃ which is an unstable intermediate product, and finally turns into Fe₂O₃(3H₂O) which is stable. Chrome elutes as Cr⁶⁺ and turns into CrO₄²⁻ which is stable in the alkaline solution. However, at the cathode, Fe(OH)₃ and Fe₂O₃(3H₂O) generated from the anode reaction are reduced to hydroxide of FeOOH or oxides of Fe₂O₃ and Fe₃O₄, and CrO₄²⁻ is reduced to hydroxide of Cr(OH)₃ or oxide of Cr₂O₃. From the XPS analysis, it is believed that carbonate ion CO₃²⁻ in the solution is co-deposited with the cathode deposits. Furthermore, the anode material is preferably made of a conventional stainless steel plate containing Cr with 13 mass % or more. When the steel material has a concentration of Cr lower than 13 mass %, the anode reaction primarily generates oxygen, so that the solubilization of iron and chrome is suppressed. For this reason, deposition at the cathode is suppressed (mostly hydrogen is generated), so that leads to unacceptably low current efficiency.

A suitable core material (stainless steel plate) for the gasket of the present invention is an austenitic stainless steel plate or a stainless steel plate having a multiphase structure of ferrite and martensite, a hardness of which is adjusted to Hv 300 to 500 with cold rolling or combination of cold rolling and heat treatment in order to give a spring property thereto. The thickness of the core material is different depending upon required characteristics, but may generally have an average thickness ranging from 0.1 to 2.0 mm, and especially from 0.15 to 0.8 mm. However, a stainless steel plate of such a thin gauge may easily be bent when it is subjected to roughening surface treatment such as shot blasting or honing. For this reason, the non-mechanical roughening surface treatment according to the present invention described above is suitable for the core material.

The rubber layer of the present invention is made from heat-resistant rubbers such as fluorocarbon rubber, silicone rubber, fluorosilicone rubber, hydrogenated acrylonitrile butadiene rubber, acrylic rubber, acrylonitrile butadiene rubber, separately or in combination, or a compound obtained by using one of the above rubbers as a binder in combination with an inorganic or organic fiber or in combination with an inorganic or organic filler. The thickness of the rubber layer ranges preferably from 10 to 500 μm on average. It is also preferable that the adhesive layer is interposed between the core material and the rubber layer. Examples of the adhesive may include resin containing epoxy resin or phenol resin as a major component. The adhesive layer is formed by coating the surface of the core material with the adhesive and then baking.

Hereinafter, embodiments will be described, and thus, the present invention will be explained in more detail.

### EXAMPLE 1

A conventional alkaline electrolytic degreasing was performed on a SUS301, 3/4H austenitic stainless steel plate (Hv about 380) with a thickness of 0.3 mm, and then it was washed with water. Next, the stainless steel plate was immersed in a solution of 42 mass % of ferric chloride at 25° C. for one minute to roughen the surface. After washing with water, the stainless steel plate was subjected to cathode electrolysis in an alkaline solution using a mixed solution of 20 g/l of sodium hydroxide, 30 g/l of trisodium phosphate·12 H₂O, and 40 g/l of sodium carbonate at 80° C. and the cathode current density of 6 A/dm², for the process times of 1.5, 2.0, 2.5, 3.0, 5.0, and 10.0 minutes. Then, the stainless steel plate was again washed with water and air dried.

In addition, for the purpose of comparison, the following sample materials were prepared: a sample material subjected to the coat-type chromate treatment (conventional alkaline degreasing followed by washing with water, and coating simultaneously both the front and rear surfaces with the coat-type chromate solution, adjusted to a predetermined concentration, by using a roll coater so that the thickness was 50±20 mg/m², a sample material subjected to dull-roll finishing, a sample material without roughening treatment, and a sample material subjected to roughening (without cathode electrolysis in the alkaline solution).

Using stainless steel plate samples as the core material, an adhesive layer containing primarily epoxy resin was formed on the surface of each sample (with a thickness of about 5 μm). Next a compound obtained by combining inorganic and organic fiber and inorganic and organic filler using acrylonitrile butadiene rubber (hereinafter, abbreviated as NBR) as a binder was coated thereon (average thickness of about 150 μm). The stainless steel plates coated with NBR were cut into sample pieces of 20×90 mm each and the sample pieces were used for the following antifreeze solution resistance test.

The antifreeze solution resistance test was performed by heating the antifreeze solution placed in an autoclave to 150° C. The sample pieces were set such that the half length of each sample piece was immersed in the antifreeze solution and the other half was exposed to the gas phase (vapor phase). The sample pieces were removed after a predetermined time, and left at room temperature for a day to dry. Thereafter,1 mm grids were inscribed on each sample piece in accordance with JISK5400, and when the sample piece was bent by 180° along the diagonal line of the grids, the number of grid cells peeled off was used as a scale of evaluation. Ten cells were evaluated and the number of cells peeled off was subtracted from 10 to give the score of the sample. The resultant score was used as the metric for evaluation. The antifreeze solutions used in the test were A, true long-life coolant by Nissan; and B, true long-life coolant by Subaru.

Results of the antifreeze solution resistance test of SUS301 samples in antifreeze solution A and antifreeze solution B are given in Table 1 and Table 2. It can be seen that the present invention had better antifreeze solution resistance than the conventional coat-type chromate treatment. The sample material subjected to dull-roll finishing and the sample material without roughening surface treatment had very poor antifreeze solution resistance. By comparing the present invention with the cathode electrolytic treatment in the alkaline solution with the sample material subjected only to the roughening treatment (without cathode electrolytic treatment in the alkaline solution), it can be seen that the antifreeze solution resistance increased remarkably.

TABLE 1
Results of the antifreeze solution resistance test of SUS301 material in
antifreeze solution A

| | | Alkaline | | 70 hours | | | 168 hours | | | 336 hours | | |
|---|---|---|---|---|---|---|---|---|---|---|---|---|
| | Roughening | electrolysis (min) | 0 | V | V/L | L | V | V/L | L | V | V/L | L |
| Present | Yes | 1.5 | 10 | 10 | 10 | 10 | 10 | 9.5 | 10 | 10 | 10 | 10 |
| invention | | 2.0 | 10 | 10 | 10 | 10 | 10 | 10 | 10 | 10 | 10 | 10 |
| | | 2.5 | 10 | 10 | 10 | 10 | 10 | 10 | 9.5 | 10 | 10 | 9 |
| | | 3.0 | 10 | 10 | 10 | 10 | 10 | 10 | 10 | 10 | 10 | 10 |
| | | 5.0 | 10 | 10 | 10 | 10 | 10 | 10 | 10 | 10 | 10 | 9.5 |
| | | 10.0 | 10 | 10 | 10 | 10 | 10 | 10 | 10 | 10 | 10 | 10 |
| Comparative | Yes | No | 10 | 10 | 7 | 5 | 5 | 3 | 0 | 3 | 0 | 1 |
| example | No | No | 10 | 8 | 0 | 2 | 0 | 0 | 0 | 0 | 0 | 0 |

| | | | | | | | | | | |
|---|---|---|---|---|---|---|---|---|---|---|
| Dull-roll finishing | 10 | 10 | 8 | 7 | 0 | 0 | 0 | 0 | 0 | 0 |
| Coat-type chromate treatment | 10 | 7.5 | 2 | 2 | 2.5 | 1 | 0 | 1 | 0 | 0 |

V: vapor phase,
V/L: vapor/liquid,
L: liquid phase

TABLE 2
Results of the antifreeze solution resistance test of SUS301 material in
antifreeze solution B

| | | Alkaline | | 70 hours | | | 168 hours | | | 336 hours | | |
|---|---|---|---|---|---|---|---|---|---|---|---|---|
| | Roughening | electrolysis (min) | 0 | V | V/L | L | V | V/L | L | V | V/L | L |
| Present | Yes | 1.5 | 10 | 10 | 10 | 10 | 10 | 9 | 8.5 | 10 | 10 | 8.5 |
| invention | | 2.0 | 10 | 10 | 10 | 10 | 10 | 10 | 10 | 10 | 10 | 8.5 |
| | | 2.5 | 10 | 10 | 10 | 9 | 10 | 10 | 8.5 | 10 | 10 | 9 |
| | | 3.0 | 10 | 10 | 10 | 10 | 10 | 10 | 9.5 | 10 | 9.5 | 8.5 |
| | | 5.0 | 10 | 10 | 10 | 10 | 10 | 10 | 10 | 9 | 10 | 7 |
| | | 10.0 | 10 | 10 | 10 | 10 | 10 | 7 | 10 | 10 | 9 | 10 |
| Comparative | No | No | 10 | 9.5 | 0 | 0 | 0 | 0 | 0 | 0 | 0 | 0 |

| | | | | | | | | | | | |
|---|---|---|---|---|---|---|---|---|---|---|---|
| example | Dull-roll finishing | 10 | 10 | 7.5 | 1 | 0 | 0 | 0 | 0 | 0 | 0 |
| | Coat-type | 10 | 8.5 | 2 | 1 | 4 | 1 | 0 | 4 | 0.5 | 0 |
| | chromate treatment | | | | | | | | | | |

V: vapor phase,
V/L: vapor/liquid,
L: liquid phase

### EXAMPLE 2

A stainless steel plate (Hv about 380) with a multiphase structure of ferrite and martensite was obtained by cold-rolling SUS410S (13Cr—0.08C) to a thickness of 0.3 mm and regulating the metal structure with continuous annealing heat treatment. This stainless steel plate was subjected to the conventional alkaline electrolytic degreasing, followed by washing with water, and the immersion in a solution of 42 mass % of ferric chloride at 25° C. for one minute, thereby roughening the surface. After water washing, the stainless steel plate was subjected to cathode electrolysis in the mixed solution of 20 g/l of sodium hydroxide, 30 g/l of trisodium phosphate·12 H₂O, and 40 g/l of sodium carbonate at the solution temperature of 80° C. and the cathode current density of 6 A/dm², for the treatment times of 1.5, 2.0, 2.5, 3.0, and 10.0 minutes. Then the stainless steel plate was again washed with water and air dried. An adhesive layer containing primarily epoxy resin (with a thickness of about 5 μm) was formed on the surface of the resultant stainless steel plate and the NBR coating layer (with an average thickness of about 150 μm) was formed thereon. The stainless steel plate coated with NBR was cut into sample pieces which were used in the antifreeze solution resistance test, as in Example 1.

Results of the antifreeze solution resistance test of SUS410S samples, with a multiphase structure of ferrite and martensite in antifreeze solution A and antifreeze solution B, are given in Table 3 and Table 4. It was found similarly to Example 1 that the present invention had better antifreeze solution resistance than the conventional coat-type chromate treatment. By comparison with Example 1, it was found that the present invention was not influenced by the properties of the core material.

TABLE 3
Results of the antifreeze solution resistance test of SUS410S, material
having a multiphase structure of ferrite and martensite in antifreeze
solution A

| | | Alkaline | | 70 hours | | | 168 hours | | | 336 hours | | |
|---|---|---|---|---|---|---|---|---|---|---|---|---|
| | Roughening | electrolysis (min) | 0 | V | V/L | L | V | V/L | L | V | V/L | L |
| Present | Yes | 1.5 | 10 | 10 | 10 | 10 | 10 | 10 | 10 | 10 | 10 | 10 |
| invention | | 2.0 | 10 | 10 | 10 | 10 | 10 | 9 | 10 | 10 | 10 | 10 |
| | | 2.5 | 10 | 10 | 10 | 10 | 10 | 10 | 10 | 10 | 10 | 10 |
| | | 3.0 | 10 | 10 | 10 | 10 | 10 | 9 | 10 | 10 | 10 | 10 |
| | | 10.0 | 10 | 10 | 10 | 10 | 10 | 9.5 | 9.5 | 10 | 7 | 8 |

| | | | | | | | | | | | |
|---|---|---|---|---|---|---|---|---|---|---|---|
| Comparative | Coat-type chromate treatment | 10 | 7.5 | 2 | 2 | 2.5 | 1 | 0 | 1 | 0 | 0 |
| example | | | | | | | | | | | |

V: vapor phase,
V/L: vapor/liquid,
L: liquid phase

TABLE 4
Results of the antifreeze solution resistance test of SUS410S, material
having a multiphase structure of ferrite and martensite in antifreeze
solution B

| | | Alkaline | | 70 hours | | | 168 hours | | | 336 hours | | |
|---|---|---|---|---|---|---|---|---|---|---|---|---|
| | Roughening | electrolysis (min) | 0 | V | V/L | L | V | V/L | L | V | V/L | L |
| Present | Yes | 1.5 | 10 | 10 | 9.5 | 9 | 10 | 10 | 10 | 10 | 10 | 10 |
| invention | | 2.0 | 10 | 10 | 10 | 8 | 10 | 2 | 10 | 10 | 4 | 10 |
| | | 2.5 | 10 | 10 | 10 | 8 | 10 | 5 | 10 | 10 | 5 | 10 |
| | | 3.0 | 10 | 10 | 10 | 8.5 | 10 | 6 | 10 | 10 | 7 | 10 |
| | | 10.0 | 10 | 10 | 6 | 10 | 10 | 6 | 4.5 | 8 | 3.5 | 7 |

| | | | | | | | | | | | |
|---|---|---|---|---|---|---|---|---|---|---|---|
| Comparative | Coat-type chromate treatment | 10 | 8.5 | 2 | 1 | 4 | 1 | 0 | 4 | 0.5 | 0 |
| example | | | | | | | | | | | |

V: vapor phase,
V/L: vapor/liquid,
L: liquid phase

In the present invention, unlike conventional coat-type chromate pre-treatment for enhancing adhesion to rubber, noxious hexavalent chrome is not eluted. This was confirmed by the following experiment (GM3034).

The stainless steel plate on which the deposits were formed with the alkali cathode electrolysis was used as a sample material. The sample was cut to a size of 5 cm×5 cm (test piece: 50 cm² including both surfaces) and the sample pieces were used in the hexavalent chrome elution test. In the hexavalent chrome elution test, ultra pure water with specific conductivity of 1×10⁻⁶ S·cm⁻¹ or less, obtained by ion-exchanging commercially available distilled water (TORAYPURE, LV-08 by Toray CO., LTD.), was used. After heating and boiling 50 ml of this ultra pure water, the sample pieces were immersed in the boiling water for 5 minutes. This completed the heating treatment. When the solution was cooled to room temperature, ultra pure water was added (to replace the quantity lost to evaporation) to restore the solution volume to exactly 50 ml.

The solution after the elution test was acidified by adding 1.5 ml of H₂SO₄ (9N) thereto and the resultant solution was divided into two 25 ml beakers. Then, 1 ml of diphenylcarbazide (0.5 g+50 ml of acetone+50 ml of ultra pure water) was added to one beaker and nothing was added to the other beaker (control solution). The two solutions were transferred to absorption cells (cell length of 1 cm), and the absorbance was measured at a wavelength of 540 nm. A calibration line was made by using reference samples of 0.5 μg/50 ml (detection limit in GM3034), 1.0 μg/50 ml, and 4.0 μg/50 ml of hexavalent chrome.

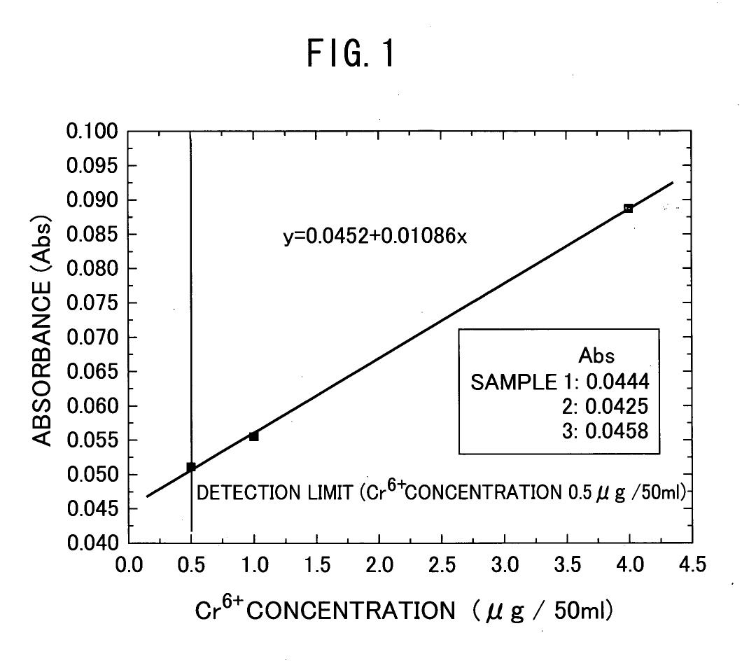

The relationship between the concentration of hexavalent chrome and the absorbance (Abs) obtained for the tests was obtained. As shown in FIG. 1, the absorbance for the samples (n=3) was 0.0425 to 0.0458, and the concentration of hexavalent chrome was 0.5 μg/50 ml (the detection limit) or less (the eluted quantity of hexavalent chrome per unit area of the sample piece was 0.01 μg/cm² or less). In addition, it was found that the concentration of hexavalent chrome could be approximated to be 0 μg/50 ml from the calibration line. Thus, it can be concluded that hexavalent chrome was not eluted from the electrolytic deposits.

The gasket made of a rubber-coated stainless steel plate according to the present invention has excellent adhesion between the rubber and the stainless steel plate and excellent resistance to antifreeze solutions. This gasket is prepared by roughening the stainless steel plate core material to provide an anchor effect and then forming the deposits of chrome hydroxide, chrome oxide, iron oxide, and iron hydroxide by cathode electrolytic treatment in alkaline solution. These deposits have excellent adhesion to an adhesive on the roughened surface of the stainless steel plate. Therefore, the adhesive and the rubber layer strongly adhere to the stainless steel plate due to the anchor effect of the core material and the effect of the composition of the deposits. When the present invention is applied to a thin plate, the plate is not bent unlike with mechanical roughening techniques. Therefore, the present invention is suitable for thin-gauged engine gaskets.

As the above descriptions show, the present invention will contribute to widespread use of gaskets made from rubber-coated stainless steel plates.

1. A stainless steel plate with a roughened surface on which chrome hydroxide, chrome oxide, iron hydroxide, and iron oxide are deposited.

2. The stainless steel plate according to claim 1, wherein the roughened surface has etch pits with an average diameter and an average depth of 0.5 to 10 μm.

3. The stainless steel plate according to claim 1 or 2, wherein the stainless steel plate is an austenitic stainless steel plate or a stainless steel plate with a multiphase structure of ferrite and martensite with a hardness of Hv 300 to 500 and an average thickness of 0.1 to 2.0 mm.

4. A rubber-coated stainless steel plate formed by coating the surface of the stainless steel plate according to any one of claims 1 to 3 with a rubber layer.

5. A rubber-coated stainless steel plate formed by coating the surface of the stainless steel plate according to any one of claims 1 to 3 with a rubber layer by using an adhesive layer.

6. The rubber-coated stainless steel plate according to claim 4 or 5, wherein the rubber layer has an average thickness of 10 to 500 μm.

7. The rubber-coated stainless steel plate according to any one of claims 4 to 6, wherein the rubber layer is made of one selected from the group consisting of fluorocarbon rubber, silicone rubber, fluorosilicone rubber, hydrogenated acrylonitrile butadiene rubber, acrylic rubber, acrylonitrile butadiene rubber, mixture of two or more thereof, or a compound obtained by using one of the above rubbers as a binder in combination with an inorganic or organic fiber or in combination with an inorganic or organic filler.

8. A gasket comprising the rubber-coated stainless steel plate according to any one of claims 4 to 7.

9. The gasket according to claim 8, wherein the gasket is an engine gasket.

10. A method of manufacturing the stainless steel plate according to claim 1 or 2, wherein the stainless steel plate is roughened with at least one of chemical roughening and electrochemical roughening and is subjected to cathode electrolytic treatment in an alkaline solution.
